(19) United States
(12) Patent Application Publication
(10) Pub. No.: US 2007/0101642 A1
(43) Pub. Date: May 10, 2007

(54) Cultivation method of agaricus blazei murill mushroom

(75) Inventor: Yong-Fang Fang, Puli Town (TW)

Correspondence Address: BIRCH STEWART KOLASCH & BIRCH, PO BOX 747, FALLS CHURCH, VA, 22040-0747, US

(73) Assignee: Yong-Fang FANG and Hsien-Chiu LIN

(21) Appl. No.: 11/269,824

(22) Filed: Nov. 9, 2005

(51) Int. Cl. A01G 1/04

(52) U.S. Cl. 47/1.1

(57) ABSTRACT

The invention relates to cultivation method of Agaricus blazei Murill mushroom which includes the following steps: preparing the mushroom spawn; inoculating spawn onto the bag-logs and carrying out the bag-log warming process; transplanting bag-logs to soil; covering casing soil onto the mushroom bed; slightly watering the mushroom bed to maintain the moisture content after the hypha germinates; conducting the induction to primordium process when the bag-logs are filled with hypha; keeping the mushroom bed ventilated and moist when the carpophores (fruiting bodies) grow up to 2 to 3 millimeters; and finally harvesting. The cultivation method of Agaricus blazei Murill mushroom according to the previously stated steps, accompanied with placing the bag-logs horizontally on the mushroom bed, while cutting open the outer plastic wraps of bag-logs with several slits before being placed so that the bag-logs won't absorb too much water and the spawn is not in contact with other strains of mushrooms to reduce the spoilage opportunity of bag-logs, is able to increase harvest yield, improve product quality, and extend harvest duration.

### BACKGROUND OF THE INVENTION

(1) Field of the Invention

The invention relates to a cultivation method of Agaricus blazei Murill mushroom, and more particularly to an artificial cultivation method of cultivating the carpophores (fruiting bodies) of Agaricus blazei Murill mushroom.

(2) Description of the Prior Art

Ever since it was imported and introduced as a commercial product, Agaricus blazei Murill mushroom has been widely accepted by the general publics as health food. Current most products made from Agaricus blazei Murill mushroom on the market are its mycelium products and not carpophores products. The reason is that cultivating the carpophores (fruiting bodies) of Agaricus blazei Murill mushroom involves the influential factors of culture medium and cultivation technology. Particularly, the cultivation technology is one of the critical factors that determine the success of high yield and quality control of the artificial cultivation of Agaricus blazei Murill mushroom.

Existing cultivation methods of Agaricus blazei Murill mushroom are similar to the cultivation methods of other strains of mushrooms, whose major characteristics include: letting the bag-logs to stand upright, removing their outer plastic wraps, utilizing straws as culture medium, and covering the bag-logs with waste soil or sand. The shortcomings of such cultivation method are listed as follows:
1. It is difficult to supplement nutrients to the upright standing bag-logs, which results in yield reduction.
2. The bag-logs with outer plastic wraps removed tend to absorb too much water and become rotten and spoiled.
3. The bag-logs with outer plastic wraps removed allow the hypha of Agaricus blazei Murill mushroom to spread too fast and produce too many carpophores (fruit bodies) at the same time, yet not able to achieve appropriate growth conditions, which results in small, short, easily aged carpophores (fruit bodies) and shortens the harvest duration.
4. The bag-logs with outer plastic wrap removed allow other strains of mushrooms to strive and improperly cover up or devour the hypha of Agaricus blazei Murill mushroom.
5. The bag-log covered with waste soil or sand produces carpophores (fruit bodies) with excessive heavy metal residues and affects consumer's health.
6. Although it is able to obtain bigger mushrooms if the bag-logs are covered with waste soil or sand, these mushrooms have higher water contents and easy to rot, so that its harvest duration is quite short.

In addition, the sand can't provide enough nutrients and vitamins required by the growth of Agaricus blazei Murill 1 mushroom.

### SUMMARY OF THE INVENTION

The primary objective of the present invention is to provide a cultivation method of Agaricus blazei Murill mushroom so that it is able to reduce the spoilage rate of the bag-logs, increase yield, and improve product quality.

The other object of the present invention is to provide a cultivation method of Agaricus blazei Murill mushroom that extends the harvest duration of the carpophores (fruiting bodies) of Agaricus blazei Murill mushroom.

The cultivation method of Agaricus blazei Murill mushroom in accordance with the present invention is an artificial cultivation method of the carpophores (fruiting bodies) of Agaricus blazei Murill mushroom, which includes the following steps: preparing the mushroom spawn; inoculating spawn onto the bag-logs and carrying out the bag-log warming process; digging up soil to form a long strip-type mushroom bed with vertical interval and horizontal breadth; placing several bag-logs in series in the intervals of the mushroom bed and grouping adjacent series together to become a strip of mushroom bed; covering casing soil onto the mushroom bed; slightly watering the mushroom bed to maintain the moisture content after the hypha germinates; proceeding the inoculation process when the bag-logs are filled with hypha; keeping the mushroom bed ventilated and moist when the carpophores (fruiting bodies) grow up to 2 to 3 millimeters; and starting to harvest 35 to 45 days after inoculation.

The cultivation method of Agaricus blazei Murill mushroom in accordance with the previously stated objectives allows the bag-logs for cultivating the carpophores (fruiting bodies) of Agaricus blazei Murill mushroom to be placed horizontally on the mushroom bed, while the outer plastic wraps of bag-logs were cut open with several slits before being placed so that the bag-logs won't absorb too much water and the spawn is not in contact with other strains of mushrooms to prevent the spoilage of bag-logs, so as to increase harvest yield and improve product quality.

The cultivated Agaricus blazei Murill mushroom according the cultivation method in accordance with the present invention, compared with the cultivated Agaricus blazei Murill mushroom obtained from the prior cultivation methods, not only has plump carpophores (fruiting bodies) and its harvest duration can last as long as 2 to 4 months.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart of the cultivation method according to the present invention;

FIG. 2A, 2B is a top view illustrating the arrangement of bag-logs according to the present invention;

FIG. 3A is a side view illustrating the location of the slits on the bag-logs;

FIG. 3B is a top view illustrating the location of the slits on the bag-logs;

FIG. 4 is a cross-sectional view illustrating the arrangement of bag-logs according to the present invention.

### DESCRIPTION OF THE PREFERRED EMBODIMENT

The invention disclosed herein is directed to a cultivation method of Agaricus blazei Murill mushroom. In the following description, numerous details are set forth in order to provide a thorough understanding of the present invention. It will be appreciated by one skilled in the art that variations of these specific details are possible while still achieving the results of the present invention. In other instance, well-known compositions are not described in detail in order not to unnecessarily obscure the present invention.

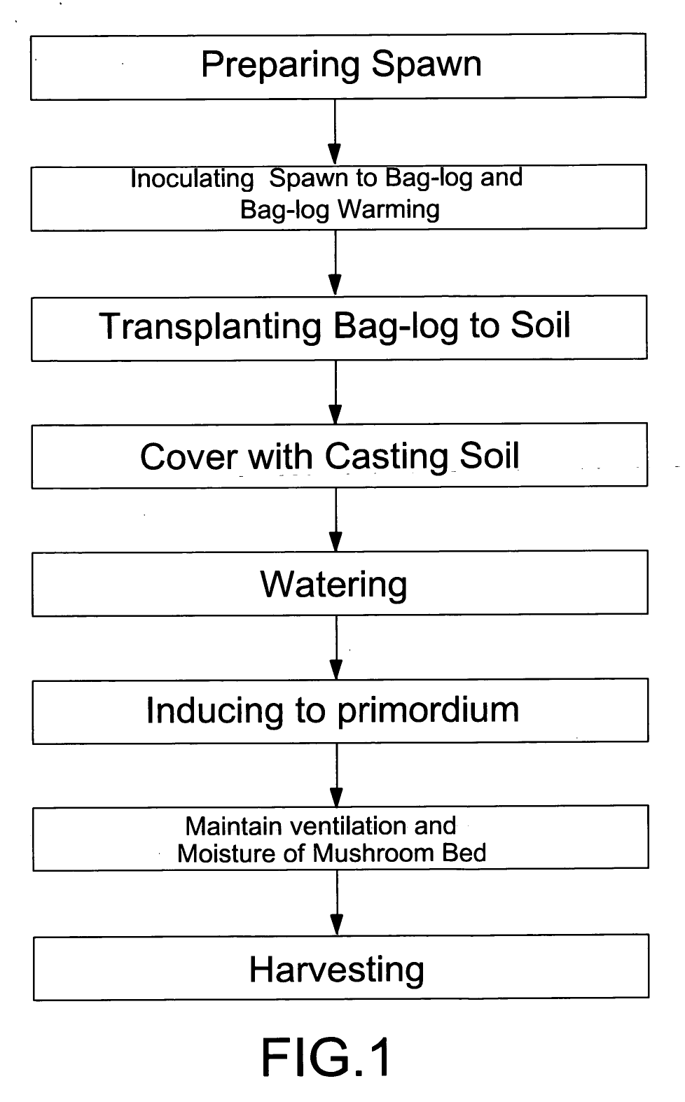

The present invention provides a preferred cultivation method of Agaricus blazei Murill mushroom, and more particularly relates to an artificial cultivation method of cultivating the carpophores (fruiting bodies) of Agaricus blazei Murill mushroom. The steps as shown in FIG. 1 are listed as follows:

Preparing Spawn

The cultivated spawn of Agaricus blazei Murill mushroom in accordance with the present invention are obtained from the nature carpophores (fruiting bodies) of Agaricus blazei Murill mushroom through the process of separating the carpophores (fruiting bodies) to become the breeder seed of Agaricus blazei Murill mushroom, then inoculating and cultivating it to become the stock culture of Agaricus blazei Murill mushroom, and later on enlarging the stock culture of Agaricus blazei Murill mushroom to become the spawn of Agaricus blazei Murill mushroom.

Inoculating Spawn to Bag-log and Bag-log Warming

The bag-log used to cultivate Agaricus blazei Murill mushroom in accordance with the present invention contains sawdust, rice bran, lime powder, and water, wherein the sawdust is preferably undergone two fermentation processes to increase the nutrients required by Agaricus blazei Murill mushroom and prevent the growth of other strains of mushrooms. After the bag-log is made, it needs to cool down before the inoculation of spawn. After the inoculation, the bag-log needs to be under the bag-log warming process for a period of time before transplanting to soil. The bag-log warming process is completed when the color of Agaricus blazei Murill mushroom bag-log appears to be white, the mycelium inside the bag-log shrinks slightly, and, when peered open, the sawdust inside the bag-log is taken up by and fused with the hypha of Agaricus blazei Murill mushroom to become white sawdust. The duration of bag-log warming process, from the making of Agaricus blazei Murill mushroom bag-log to the fully mature of hypha, takes about 3 to 4 months of spawn running period to become suitable for cultivation.

Transplanting Bag-log to Soil

It is preferred that the land used for planting Agaricus blazei Murill mushroom has not been used for planting agriculture products for 4 to 5 years. In addition, it is preferred to build an indoor environment to eliminate the uncontrollable factors of outdoor environment after the cultivating location for Agaricus blazei Murill mushroom is determined.

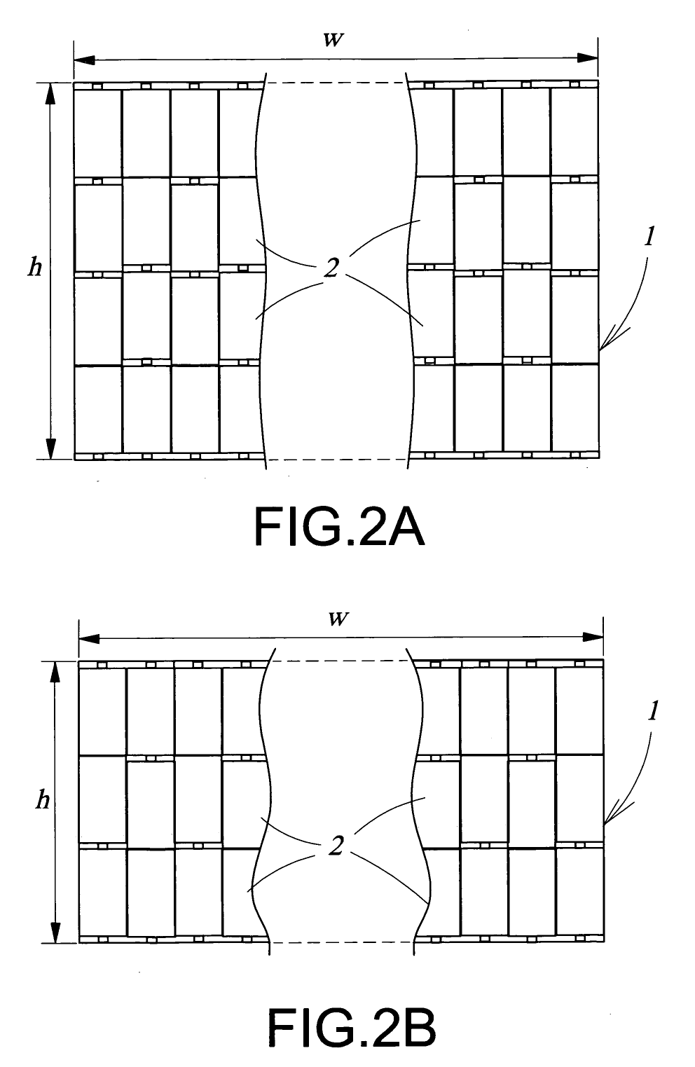

For planting, the land is dug out sideway to form a mushroom bed 1 with vertical interval h and horizontal breadth w, as shown in FIG. 2A and 2B. Bag-log 2 are placed horizontally on said mushroom bed 1, wherein several said bag-logs 2 are arranged in series in said vertical interval h of said mushroom bed 1, preferably placing three (FIG. 2A) or four (FIG. 2B) of said bag-logs 2. Several series of said bag-logs 2 are arranged adjacent to each other in said breadth w of said mushroom bed 1.

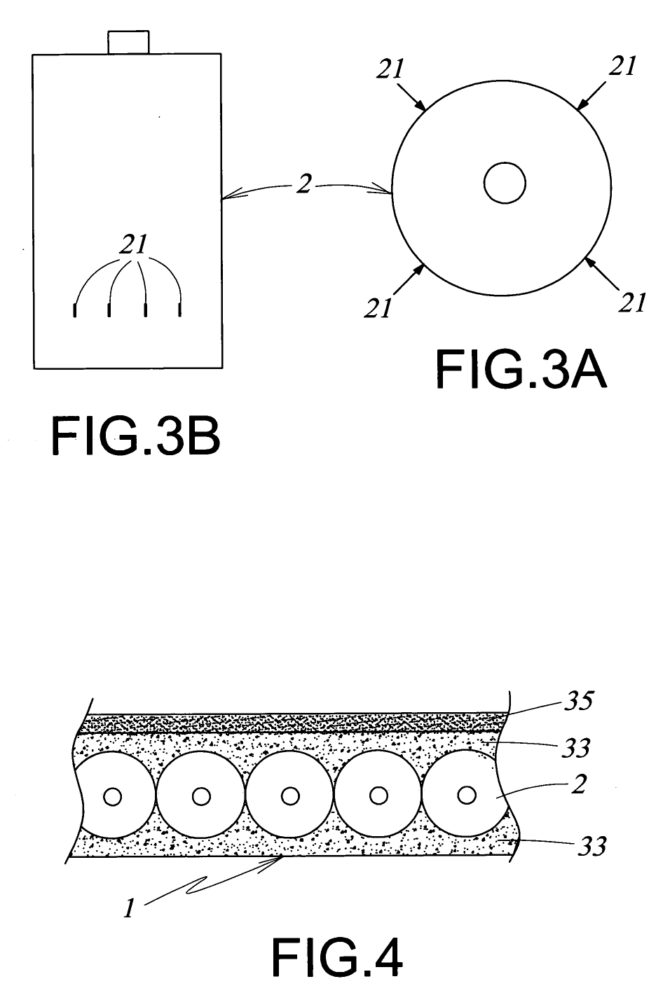

Before placing previously stated said bag-log 2 onto said mushroom bed 1, the outer plastic wrap of said bag-log is cut to create several slits 21, preferably about 3 to 4 slits, as shown in FIG. 3. Said slits 21 are spaced at interval around the outer rim of said bag-log 2, as shown in FIG. 3A, or concentrated at one outer rim location, as shown in FIG. 3B. The purpose of creating said slits 21 at the surface of said bag-log 2 is to prevent said bag-log 2 from absorbing too much water, the spawn of Agaricus blazei Murill mushroom coming into contact with other strains of mushrooms so to reduce the opportunity of bag-log spoilage (unable to grow the carpophores of Agaricus blazei Murill mushroom), and reducing the spreading speed of Agaricus blazei Murill mushroom hypha so that the carpophores (fruiting bodies) do not grow at the same time, which allows the carpophores (fruiting bodies) to be able to fully absorb nutrients and grow, leading to harvest yield increase and product quality improvement.

Covering with Casing Soil

It is required to cover casing soil onto said bag-logs 2 in each said mushroom bed 1 the same day after they are arranged in order to prevent direct sunlight that causes the necrosis of hypha. Continue to cover casing soil until it fully covers said bag-logs 2, as shown in FIG. 4, preferably 3 to 3,5 centimeters higher than said bag-logs 2. Said casing soil in accordance with the present invention is preferably to interlay unprocessed soil and culture medium as separate layers so that: allowing the hypha of Agaricus blazei Murill mushroom during growth period to have enough density and growing space, and possessing the moisture maintaining effect, to mature and grow carpophores (fruiting bodies); furthermore, the culture medium can further provide Agaricus blazei Murill mushroom sufficient nutrients to grow carpophores (fruiting bodies).

The method of covering with casing soil in accordance with the present invention, as shown in FIG. 4, is to conduct the casing soil covering tasks in sequence, starting from the bottom layer of said culture medium 33, said bag-log 2, said culture medium 33, to the top layer of said unprocessed soil 35.

Watering

10 to 15 days after the mushroom bed of Agaricus blazei Murill mushroom is completed, hypha starts to germinate, mixes with culture medium, and absorbs the nutrients in the culture medium. Around the 30ₜₕ day of cultivation, the mycelium has completely absorbed the culture medium and formed a layer of white hypha. Then, it is able to slightly sprinkle some water to maintain the consistent moisture content of mushroom bed.

Inducing to Primordium

It begins the inducement to primordium process when hypha covers the entire culture medium, around 25 to 30 days after the completion of mushroom bed. The inducement to primordium process is conducted by watering the mushroom bed, preferably 1 to 3 times every day. It is preferred to performing the watering tasks during morning and evening hours, since the air temperature is quiet high at noon and the low temperature water may cause the temperature difference in the mushroom bed and result in the necrosis of hypha or delaying the growth of carpophores (fruiting bodies).

Maintaining Ventilation and Moisture of Mushroom Bed

When the carpophores (fruiting bodies) grow up to 2 to 3 millimeters, the inducement to primordium process of regularly watering everyday should be stopped to prevent being over-moisturized to result in the rottenness of carpophores (fruiting bodies). Furthermore, it is required to maintain the ventilation of the mushroom bed but avoid wind directly blowing at the mushroom bed to prevent the carpophores (fruiting bodies) from stop-growing, fast withered, or deformed. Proper watering to maintain its moisture if the mushroom bed is too dry, but avoid over-wetting.

Harvesting

It can start to harvest the Agaricus blazei Murill mushroom 35 to 45 days after planting, and harvest duration may last 2 to 4 months.

The carpophores (fruiting bodies) produced by utilizing the cultivation method of Agaricus blazei Murill mushroom in accordance with the present invention, because of adequate growing space and the fully absorption of nutrients by each carpophore, are able to achieve uniform-size mushrooms (over 3 centimeters high), and, because the mushrooms have low water content, they are not easily to rot so as to extend their harvest duration.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

I claim:

1. A cultivation method of Agaricus blazei Murill mushroom, including the following steps:
a. preparing spawn,
b. inoculating spawn to bag-log and bag-log warming
c. transplanting said bag-log to soil
d. covering with casing soil,
e. watering,
f. inducing to primordium,
g. maintaining ventilation and moisture of mushroom bed, and
h. harvesting.

2. A method according to claim 1, wherein said preparing spawn step is to obtained the cultivation spawn from the carpophores (fruiting bodies) of Agaricus blazei Murill mushroom through the processes of separating said carpophores, inoculating and cultivating, and expanding stock culture.

3. A method according to claim 1, wherein the duration of said bag-log warming step for said bag-logs is 3 to 4 months.

4. A method according to claim 1, wherein said bag-log is placed on said long strip-type mushroom bed with vertical interval and horizontal breadth.

5. A method according to claim 4, wherein several said bag-logs are arranged in series along the intervals of said mushroom bed and grouped with adjacent series.

6. A method according to claim 5, wherein said interval is placed with 4 bag-logs of Agaricus blazei Murill mushroom.

7. A method according to claim 1, wherein the thickness of said casing soil is to fully cover the said bag-logs.

8. A method according to claim 1, wherein the thickness of said lo casing soil is 3 to 3.5 centimeters higher than the said bag-logs.

9. A method according to claim 1, wherein hypha germinates 10 to 15 days after the completion of said mushroom bed.

10. A method according to claim 1, wherein start to water and maintain the moisture of said mushroom bed 25 to 30 days after the completion of said mushroom bed.

11. A method according to claim 1, wherein said inducing to primordium step means to water said mushroom bed 1 to 3 times everyday to be slightly moist and until said carpophores (fruiting bodies) of Agaricus blazei Murill grow out.

12. A method according to claim 1, wherein said inducing to primordium step means to water said mushroom bed once both during morning and evening hours everyday.

13. A method according to claim 11, wherein said inducing to primordium step means to water said carpophores (fruiting bodies) of Agaricus blazei Murill until they grow up to 2 to 3 millimeters.

14. A method according to claim 1, wherein before placing said bag-logs onto said mushroom bed, the outer plastic wraps of said bag-logs are cut to create 3 to 4 slits.

15. A method according to claim 1, wherein said Agaricus blazei Murill is able to be harvested 35 to 45 days after planting.

16. A method according to claim 1, wherein the harvest duration of said Agaricus blazei Murill lasts 2 to 4 months.

17. A method according to claim 1, wherein the materials of said bag-logs include sawdust, rice bran, lime powder, and water.

18. A method according to claim 1, is conducted inside an indoor environment.
